(19) United States
(12) Patent Application Publication
(10) Pub. No.: US 2013/0227229 A1
(43) Pub. Date: Aug. 29, 2013

(54) SEMICONDUCTOR DEVICE THAT BURST-OUTPUTS READ DATA

(71) Applicant: Elpida Memory, Inc., (US)

(72) Inventor: Toru Ishikawa, Tokyo (JP)

(73) Assignee: Elpida Memory, Inc., Tokyo (JP)

(21) Appl. No.: 13/773,502

(22) Filed: Feb. 21, 2013

(30) Foreign Application Priority Data
Feb. 29, 2012 (JP) 2012-044654

(51) Int. Cl. G06F 12/00

(52) U.S. Cl. CPC G06F 12/00
USPC 711/154

(57) ABSTRACT

A semiconductor device includes a command terminal, a plurality of memory banks, a control circuit and an output circuit. The control circuit is configured to respond to each of issuance of a read command, that is supplied to the command terminal, to perform a read operation on any one of the memory banks so that the any one of the memory banks output a plurality of read data sets. The output circuit receives the read data sets and outputs the read data sets to outside in response to a clock signal so that a first interval substantially the same as a period of the clock signal or longer than the period of the clock signal is interposed between the read data sets.

### BACKGROUND OF THE INVENTION

1. Field of the Invention The present invention relates to a semiconductor device, an information processing system including the same, and a method for controlling the semiconductor device. In particular, the present invention relates to a semiconductor device that burst-outputs a plurality of read data in response to a read command, an information processing system including the same, and a method for controlling the semiconductor device.

2. Description of Related Art

A semiconductor memory device, such as a Dynamic Random Access Memory (DRAM), includes a memory cell array typically divided into a plurality of memory banks (see Japanese Patent Application Laid-Open Nos. 2000-82287, 2011-165298, and 2011-175563). Memory banks are capable of individual command execution. Memory banks can thus be accessed in a nonexclusive manner.

For example, a semiconductor memory device described in Japanese Patent Application Laid-Open No. 2000-82287 automatically executes “bank interleaving” to alternately access two memory banks. Read data is thereby burst-output a plurality of times in successive manner. A semiconductor memory device described in Japanese Patent Application Laid-Open No. 2011-165298 outputs read data from banks 0 to 7 through data terminals DQ0 to DQ7, respectively. Data stored in the banks 0 to 7 in a distributed manner can thus be efficiently output. A semiconductor memory device described in Japanese Patent Application Laid-Open No. 2011-175563 includes memory banks that are further divided into a plurality of blocks each. Blocks to be accessed and the output order can be selected based on a burst length select signal, a block select signal, etc.

In the semiconductor memory devices described in Japanese Patent Application Laid-Open Nos. 2000-82287, 2011-165298, and 2011-175563, a plurality of read data read in response to a single read command are continuously output from a data terminal or terminals in succession. Consequently, the speed of reading the read data from the memory banks in response to a read command is designed to allow continuous burst output.

A semiconductor memory device of so-called wide I/O type having a large number of data terminals has recently been proposed. Such a type of semiconductor memory device reads a large number of bits of read data from memory banks in response to a read command. For example, if the burst length is four bits and the number of data terminals is 32, the number of bits of read data to be read from the memory banks in response to a read command is 128 (=4×32). If the number of data terminals is 64, the number is 256 (=4×64).

When the number of data terminals is 64, sense amplifiers twice as many as when the number of data terminals is 32 need to be simultaneously activated, providing that the memory banks have the same array configuration. For example, suppose the number of data terminals is 32 and the number of sense amplifiers simultaneously activated is 2 Kbytes. If the number of data terminals is 64, then the number of sense amplifiers simultaneously activated doubles to be 4 Kbytes. This increases the amount of peak current as well as power supply noise.

The array configuration may be changed to reduce the number of sense amplifiers to be simultaneously activated. Even if the number of data terminals is 64, the array configuration can be changed to keep the number of data terminals to be simultaneously activated the same as when the number of data terminals is 32. However, such a configuration increases the number of lines of data interconnection formed on the array, with a significant increase in the chip area.

Under the circumstances, a technology for suppressing an increase of the number of sense amplifiers simultaneously activated without increasing the chip area has been desired. Such a technology has been desired not only of semiconductor memory devices such as a DRAM, but also of all semiconductor devices having a plurality of memory banks and information processing systems using the same.

### SUMMARY

In one embodiment, there is provided a semiconductor device that includes: a command terminal configured to receive a read command; a plurality of memory banks; a control circuit configured to respond to each of issuance of the read command to perform a read operation on one of the memory banks so that the one of the memory banks outputs a plurality of read data sets; and an output circuit configured to output the read data sets to outside in response to a clock signal so that a first interval is interposed between the read data sets, the first interval being substantially the same as a clock cycle of the clock signal or longer than the clock cycle.

In another embodiment, there is provided a device that includes: a command terminal configured to receive a read command; a data terminal; a first memory bank configured to store a plurality of first data, the plurality of data including first and second read data; a holding circuit coupled to the first memory bank and configured to hold at most a first number of data; an output circuit coupled between the holding circuit and the data terminal; and a control circuit configured to respond to a first issuance of the read command to produce first and second access signals, and wherein the first memory bank outputs the first read data to the output circuit with an intervention of the holding circuit in response to the first access signal and outputs the second read data to the output circuit with an intervention of the holding circuit in response to the second access signal, the output circuit intermittently supplies the first and second read data to the data terminal, and each of the first and second read data is equal in data size to the first number of data.

In another embodiment, there is provided device includes: a plurality of memory banks; a command terminal operatively receiving a read command; an address terminal operatively receiving a bank address that designates one of the memory banks; and a register circuit operatively storing burst length information that designates the number of read data output from the data terminal in response to each issuance of the read command, wherein the device operatively responds to a first issuance of the read command to output a plurality of sets of first read data from one of the memory banks designated by a first bank address, the sets of first read data include the number of data designated by the burst length information, and the device operatively intermittently produces the sets of first read data at the output terminal.

### BRIEF DESCRIPTION OF THE DRAWINGS

FIG. 1 is a block diagram of the semiconductor device according to a first embodiment of the present invention;

FIG. 2 is a circuit diagram of the control signal generation circuit included in the column control circuit 100;

FIG. 3 is a circuit diagram of the control signal generation circuit included in the column control circuit 200;

FIG. 4 is a timing chart of the control signal generation circuits;

FIG. 5A is a table of the logic levels of selection signals in case of operation according to the first embodiment;

FIG. 5B is a table of the logic levels of selection signals in case of typical operation;

FIG. 6 is a timing chart showing the bank interleaving operation of the semiconductor device according to the first embodiment in a read operation;

FIG. 7 is a timing chart showing the bank interleaving operation of the semiconductor device according to the first embodiment in a write operation;

FIG. 8 is a timing chart showing the operation of the semiconductor device, especially normal read access with designating memory bank BANK0;

FIG. 9 is a timing chart of read operation using data strobe signal, especially bank interleaving in read;

FIG. 10 is a timing chart of write operation using data strobe signal, especially normal write access with designating memory bank BANK0;

FIG. 11 is a block diagram of the semiconductor device according to a second embodiment of the present invention;

FIG. 12 is a timing chart of the semiconductor device according to the second embodiment, especially the length of burst is two bits;

FIG. 13 is a block diagram of the semiconductor device according to a third embodiment of the present invention;

FIG. 14 is a timing chart of the semiconductor device according to the third embodiment, especially bank interleaving in read;

FIG. 15 is a block diagram of the semiconductor device according to a fourth embodiment of the present invention;

FIG. 16 is a timing chart of the semiconductor device according to the fourth embodiment, especially bank interleaving in read;

FIG. 17A shows layout of global I/O lines in a planar view;

FIG. 17B shows layout of another global I/O lines in a planar view;

FIG. 18 is a timing chart of the semiconductor device according to the fourth embodiment, especially bank interleaving mixed with reading and writing;

FIG. 19 is a block diagram of the information processing system according to a fifth embodiment of the present invention;

FIG. 20 is a block diagram of the information processing system according to a sixth embodiment of the present invention; and

FIG. 21 is a block diagram of the information processing system according to a seventh embodiment of the present invention.

### DETAILED DESCRIPTION OF THE EMBODIMENTS

Preferred embodiments of the present invention will be explained below in detail with reference to the accompanying drawings. The following detailed description refers to the accompanying drawings that show, by way of illustration, specific aspects and embodiments in which the present invention may be practiced. These embodiments are described in sufficient detail to enable those skilled in the art to practice the present invention. Other embodiments may be utilized, and structure, logical and electrical changes may be made without departing from the scope of the present invention. The various embodiments disclosed herein are not necessarily mutually exclusive, as some disclosed embodiments can be combined with one or more other disclosed embodiments to form new embodiments.

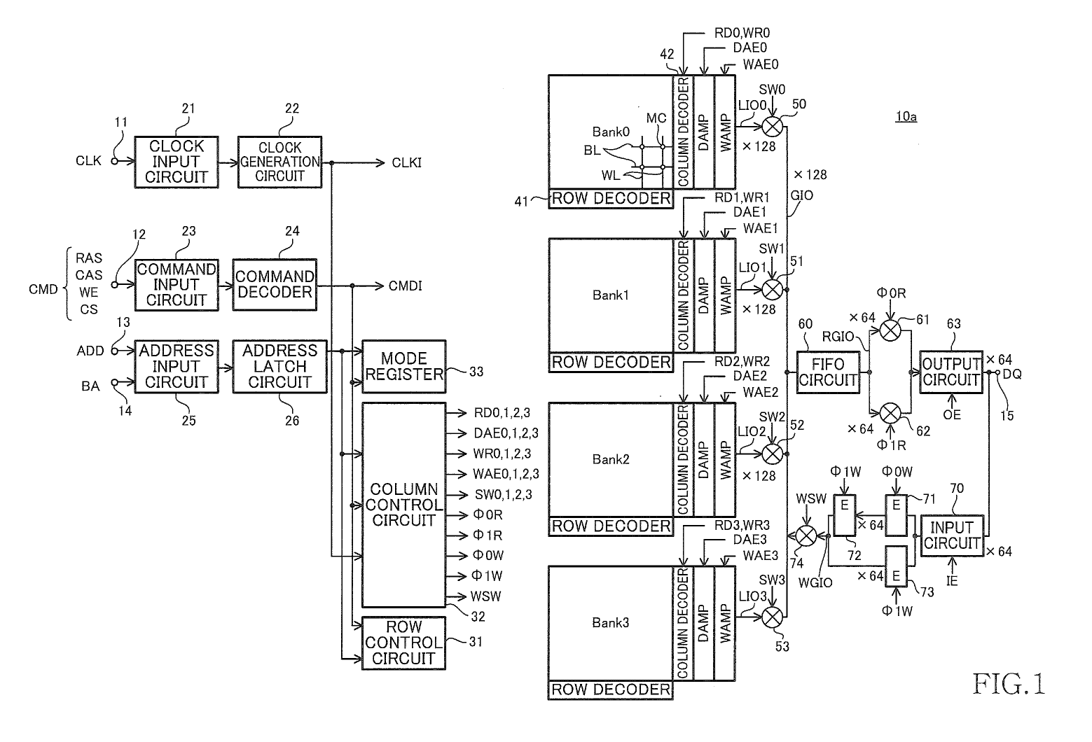

Referring now to FIG. 1, the semiconductor device 10a according to the first embodiment of the present invention is a DRAM, which is integrated as a single semiconductor chip. As shown in FIG. 1, the semiconductor device 10a according to the present embodiment has external terminals including a clock terminal 11, a command terminal 12, an address terminal 13, a bank address terminal 14, and data terminals 15. The external terminals also include power supply terminals and a calibration terminal, which are not directly related to the gist of the present invention and a description thereof will thus be omitted. In the present embodiment, the number of data terminals 15 is 64. In other words, 64 bits of data is input or output at a time.

The clock terminal 11 is supplied with an external clock signal CLK from outside the semiconductor device 10a. The external clock signal CLK input to the clock terminal 11 is supplied to a clock generation circuit 22 through a clock input circuit 21. The clock generation circuit 22 generates an internal clock signal CLKI based on the external clock signal CLK. The internal clock signal CLKI is supplied to various circuit blocks including a row control circuit 31, a column control circuit 32, and a mode register 33 to be described later, and is used as a timing signal for defining operation timing of the semiconductor device 10a.

The command terminal 12 is supplied with external command signals CMD from outside the semiconductor device 10a. The external command signals CMD include a row address strobe signal RAS, a column address strobe signal CAS, a write enable signal WE, and a chip select signal CS. Command types are expressed by combinations of such signals. The external command signals CMD input to the command terminal 12 are supplied to a command decoder 24 through a command input circuit 23. The command decoder 24 generates an internal command signal CMDI based on the combination of the external command signals CMD. The internal command signal CMDI is supplied to the row control circuit 31, the column control circuit 32, the mode register signal 33 to be described later, etc.

The address terminal 13 and the bank address terminal 14 are terminals to which an address signal ADD and a bank address signal BA are supplied from outside the semiconductor device 10a, respectively. The address signal ADD and the bank address BA input to the terminals 13 and 14 are supplied to an address latch circuit 26 through an address input circuit 25. The address signal ADD and the bank address signal BA retained in the address latch circuit 26 are supplied to the row control circuit 31, the column control circuit 32, or the mode register 33 based on the internal command signal CMDI.

Specifically, if the internal command signal CMDI indicates a row access, the address signal ADD and the bank address signal BA retained in the address latch circuit 26 are supplied to the row control circuit 31. The row control circuit 31 selects a memory bank indicated by the bank address BA and supply the address signal ADD to a row decoder 41 corresponding to the selected memory bank. The address signal ADD supplied to the row decoder 41 may be referred to as a row address. The row decoder 41 selects a word line WL in the memory bank based on the address signal ADD (row address). The internal command signal CMDI indicates a row access when the external command signals CMD indicate an active command.

If the internal command signal CMDI indicates a column access, the address signal ADD and the bank address BA retained in the address latch circuit 26 are supplied to the column control circuit 32. The column control circuit 32 selects a memory bank indicated by the bank address signal BA and supply the address signal ADD to a column decoder 42 corresponding to the selected memory bank. The address signal ADD supplied to the column decoder 42 may be referred to as a column address. The column decoder 42 selects bit lines BL in the memory bank based on the address signal ADD (column address). The internal command signal CMDI indicates a column access when the external command signals CMD indicate a read command or a write command.

If the external command signals CMD indicate a read command, the column control circuit 32 activates any one of read signals RD0 to RD3 and any one of enable signals DAE0 to DAE3 based on the bank address signal BA. If the external command signals CMD indicate a write command, the column control circuit 32 activates any one of write signals WR0 to WR3 and any one of enable signals WAE0 to WAE3 based on the bank address signal BA.

Consequently, when an active command and a read command are issued in that order and a row address and a column address are input in synchronization with the respective commands, data can be read from the memory cells MC designated by such addresses. When an active command and a write command are issued in that order and a row address and a column address are input in synchronization with the respective commands, data can be written into the memory cells MC designated by such addresses.

If the internal command signal CMDI indicates mode register setting, the address signal ADD (mode signal) retained in the address latch circuit 26 is supplied to the mode register 33. The mode register 33 is a circuit in which various mode signals indicating operation modes of the semiconductor device 10a are set. When the internal command signal CMDI indicates mode register setting, the bank address signal BA selects a plurality of registers constituting the mode register 33.

As shown in FIG. 1, the semiconductor device 10a according to the present embodiment includes four memory banks Bank0 to Bank3. The memory banks are capable of individual command execution. The memory banks can thus be accessed in a nonexclusive manner. In the present invention, the number of memory banks is not limited in particular. For example, eight memory banks may be included.

The memory banks Bank0 to Bank3 each include a row decoder 41 and a column decoder 42. The memory banks Bank0 to Bank3 each include a plurality of word lines WL and a plurality of bit lines BL, at intersections of which are arranged memory cells MC. As described above, when the row decoder 41 selects a word line WL and the column decoder 42 selects bit lines BL, the memory cells MC arranged at the intersections can be accessed. In a read operation, the operation timing of the column decoder 42 is controlled by the corresponding read signal RD0, RD1, RD2, or RD3. In a write operation, the operation timing of the column decoder 42 is controlled by the corresponding write signal WR0, WR1, WR2, or WR3.

In a read operation, when a corresponding read signal RD0, RD1, RD2, or RD3 is activated, read data selected by the column address read from the memory bank by a row access is supplied to a data amplifier DAMP. The data amplifiers DAMP are activated by the corresponding enable signals DAE0 to DAE3, and function to further amplify selected read data. The read data amplified by the data amplifiers DAMP is transferred to corresponding local I/O interconnections LIO0 to LIO3.

In the present embodiment, the number of memory cells MC selected by a single row access is, though not limited to, 2 Kbytes. Of these, 128 memory cells MC are selected by a column access. In other words, when a row decoder 41 selects a word line WL, 2 Kbytes of memory cells MC are connected to not-shown sense amplifiers and read data is amplified by the sense amplifiers. The corresponding column decoder 42 selects 128 bits of read data from among the 2 Kbytes of read data, and transfers the 128 bits of read data to corresponding local I/O interconnections LIO0, LIO0, LIO2, or LIO3.

The 128 bits of read data transferred to the local I/O interconnections LIO0, LIO0, LIO2, or LIO3 is transferred to a global I/O interconnection GIO through a corresponding switch circuit 50, 51, 52, or 53. The switch circuits 50 to 53 are controlled by respective switch control signals SW0 to SW3 supplied from the column control circuit 32.

As shown in FIG. 1, the global I/O interconnection GIO includes signals lines that are allocated to the four memory banks Bank0 to Bank3 in common. The global I/O interconnection GIO has a data width of 128 bits. The 128 bits of read data transferred to the global I/O interconnection is transferred to a global I/O interconnection RGIO in 64 bits twice by a FIFO circuit 60. Two switch circuits 61 and 62 are connected to the global I/O interconnection RGIO in parallel, and controlled by respective switch control signals φ0R and φ1R. The switch control signals φ0R and φ1R are supplied from the column control circuit 32 in a read operation. As a result, the 128 bits of read data is serially converted into 64 bits×2 and supplied to an output circuit 63.

The output circuit 63 is activated based on an enable signal OE supplied from the column control circuit 32 in a read operation. Consequently, 64 bits of read data is output from the data terminals 15 twice. The detailed operation timing in a read operation will be described later.

Now, in a write operation, 64 bits of write data is input from outside to the 64 data terminals 15 twice. The 64 bits of write data is supplied to switch circuits 71 to 73 through an input circuit 70. The input circuit 70 is activated based on an enable signal IE supplied from the column control circuit 32 in a write operation.

As shown in FIG. 1, the switch circuits 71 and 73 are connected in parallel. The switch circuits 71 and 72 are connected in series. The switch circuit 71 is controlled by a switch control signal φ0W. The switch circuits 72 and 73 are controlled by a switch control signal φ1W. The switch control signals φ0W and φ1W are supplied from the column control circuit 32 in a write operation. As a result, two 64 bits of write data are parallel-converted into 128 bits of data and supplied to a global I/O interconnection WGIO. The 128 bits of write data supplied to the global I/O interconnection WGIO is transferred to the global I/O interconnection GIO through a switch circuit 74. The switch circuit 74 is controlled by a switch control signal WSW supplied from the column control circuit 32 in a write operation.

The 128 bits of write data transferred to the global I/O interconnection GIO is transferred to anyone of the groups of local I/O interconnection LIO0 to LIO3 through the corresponding one of the switch circuits 50 to 53. The 128 bits of write data transferred to any one of the groups of local I/O interconnection LIO0 to LIO3 is amplified by a write amplifier WAMP activated by the corresponding one of the enable signals WAE0 to WAE3. The write data amplified by the write amplifier WAMP is written to selected memory cells MC when the corresponding one of the write signals WR0 to WR3 is activated. The detailed operation timing in a write operation will also be described later.

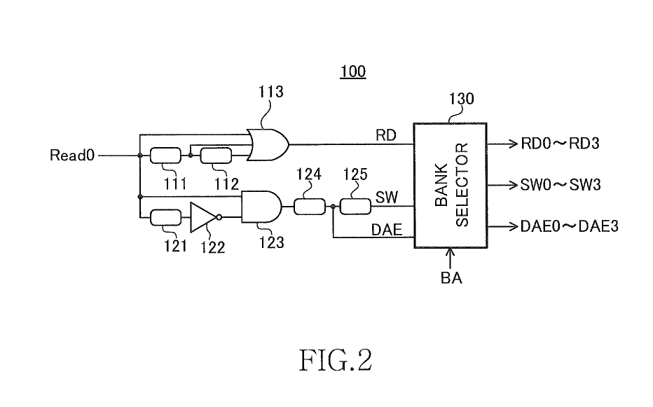

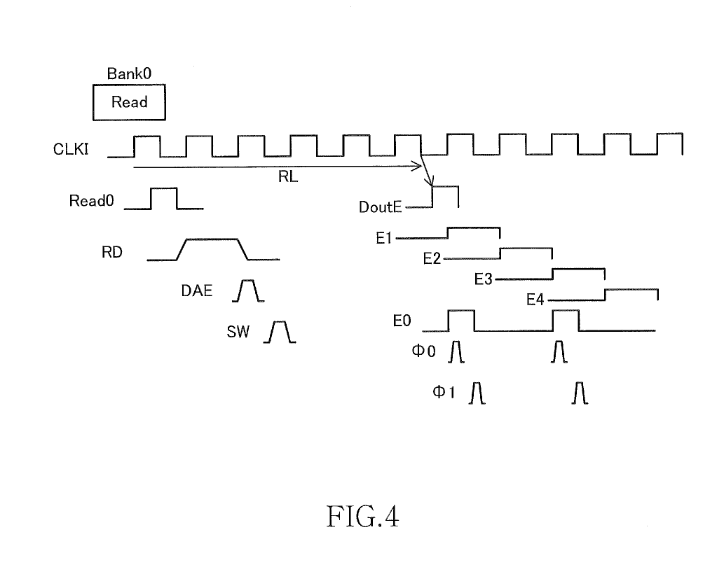

Turning to FIG. 2, the control signal generation circuit 100 generates the read signals RD0 to RD3, the enable signals DAE0 to DAE3, and the switch control signals SW0 to SW3 in response to an internal read command Read0 which is generated in the column control circuit 32 when a read command is issued. As shown in FIG. 2, the control signal generation circuit 100 includes delay circuits 111 and 112 to which the internal read command Read0 is supplied, and an OR gate circuit 113. The delay circuits 111 and 112 are connected in series. The OR gate circuit 113 is a three-input gate circuit which receives the internal read command Read0 and the output signals of the delay circuits 111 and 112. As shown in an operation waveform chart of FIG. 4, the OR gate circuit 113 expands the pulse width of the internal read command Read0 to generate a read signal RD. The read signal RD is supplied to a bank selector 130.

The control signal generation circuit 100 further includes a one-shot pulse generation circuit which includes a delay circuit 121, an inverter 122, and an AND gate circuit 123, and delay circuits 124 and 125 which delay the output signal of the one-shot pulse generation circuit. The delay circuits 124 and 125 are connected in series. The output signal of the delay circuit 124 is used as an enable signal DAE. The output signal of the delay circuit 125 is used as a switch control signal SW. As shown in FIG. 4, when the internal read command Read0 is activated, the enable signal DAE and the switch control signal SW, both being a one-shot pulse, are activated in that order. The enable signal DAE and the switch control SW are supplied to the bank selector 130.

The bank selector 130 receives the read signal RD, the enable signal DAE, and the switch control signal SW, and activates any one of the read signals RD0 to RD3, any one of the enable signals DAE0 to DAE3, and any one of the switch control signals SW0 to SW3 based on the bank address signal BA. For example, if the bank address signal BA designates the memory bank Bank0, the bank selector 130 activate the read signal RD0, the enable Signal DAE0, and the switch control signal SW0 based on the read signal RD, the enable signal DAE, and the switch control signal SW.

Although not shown in the drawings, the write signals WR0 to WR3 and the enable signals WAE0 to WAE3 needed for a write operation are configured as a circuit similar to the control signal generation circuit 100 shown in FIG. 2.

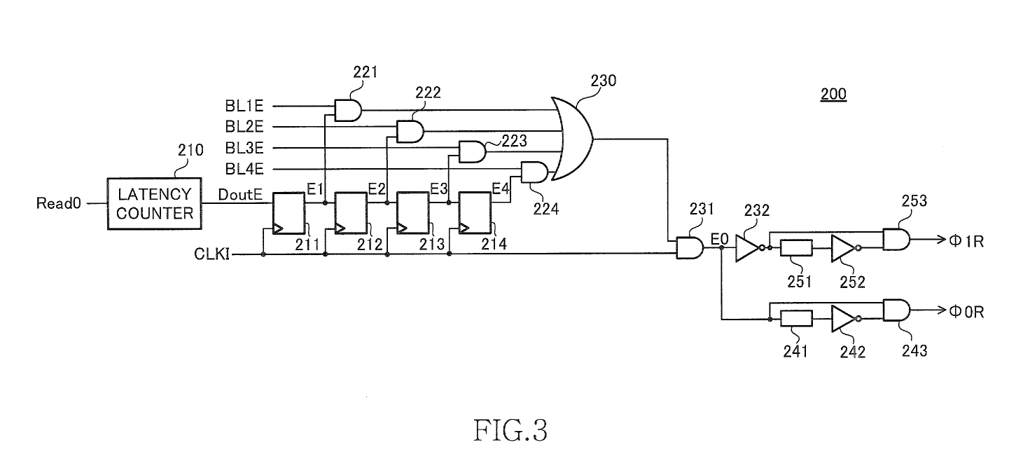

Turning to FIG. 3, the control signal generation circuit 200 generates the switch control signals φ0R and φ1R in response to the internal read command Read0. As shown in FIG. 3, the control signal generation circuit 200 includes a latency counter 210 and latch circuits 211 to 214. The latency counter 210 generates an output start signal DoutE in response to the internal read command Read0. The latch circuits 211 to 214 receive the output start signal DoutE and generate enable signals E1 to E4. As shown in the timing chart of FIG. 4, the latency counter 210 activates the output start signal DoutE at timing when a read latency RL set in the mode register 33 has elapsed since the activation of the internal read command Read0.

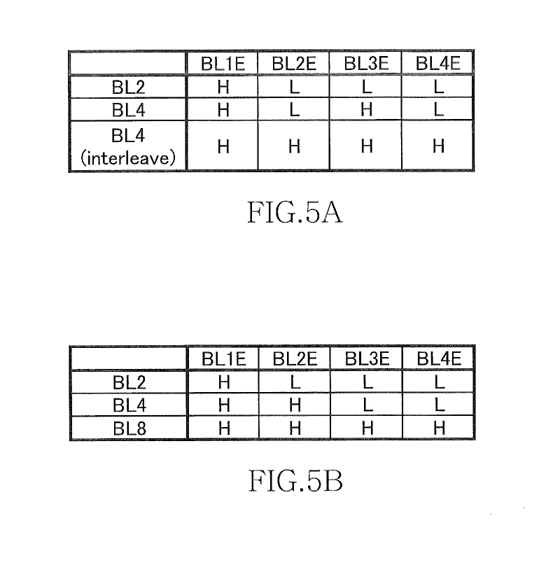

As shown in FIG. 3, the latch circuits 211 to 214 for receiving the output start signal DoutE are cascaded to perform a shift operation in synchronization with the internal clock signal CLKI. When the output start signal DoutE is activated, the enable signals E1 to E4 are activated in that order in synchronization with the internal clock signal CLKI. The enable signals E1 to E4 are connected to either one of input nodes of AND gate circuits 221 to 224, respectively. The other input nodes of the AND gate circuits 221 to 224 are supplied with select signals BL1E to BL4E, respectively. The select signals BL1E to BL4E are set to logic levels shown in FIG. 5A based on a burst length value and the presence or absence of bank interleaving set in the mode register 33.

Bank interleaving refers to an access operation that is performed when read commands or write commands are consecutively issued for different memory banks. In the present embodiment, it applies when the read commands or write commands are consecutively issued at an interval of one clock cycle. As shown in FIG. 5A, if the burst length is two bits (=BL2), only the select signal BL1E is set to a high level. If the burst length is four bits (=BL4), the select signals BL1E and BL3E are set to a high level. If the burst length is four bits (=BL4) and bank interleaving is performed, all the select signals BL1E to BL4E are set to a high level. The settings of the mode register 33 may be modified so that the logic levels of the select signals BL1E to BL4E are set to the values shown in FIG. 5B. In such a case, the same operations as those of a typical DRAM are performed. Such an operation mode is effective when the external clock signal CLK has a sufficiently low frequency.

As shown in FIG. 3, the output signals of the AND gate circuits 221 to 224 are input to an OR gate circuit 230. The output signal of the OR gate circuit 230 and the internal clock signal CLKI are input to an AND gate circuit 231 and output as a timing signal E0. FIG. 4 shows an example where the burst length is four bits (=BL4) and bank interleaving is not performed. The timing signal E0 is thus activated in synchronization with the select signals BL1E and BL3E.

The timing signal E0 is supplied to a one-shot pulse generation circuit that includes a delay circuit 241, an inverter 242, and an AND gate circuit 243. The timing signal E0 is inverted by an inverter 232 and then supplied to a one-shot pulse generation circuit that includes a delay circuit 251, an inverter 252, and an AND gate circuit 253. Consequently, the switch control signal φ0R is activated in synchronization with the rising edges of the timing signal E0. The switch control signal φ1R is activated in synchronization with the falling edges of the timing signal E0. In the example shown in FIG. 4, the switch control signals φ0R and φ1R are each activated twice, with an interval of two clock cycles. The interval between the activation timing of the switch control signal φ0R and that of the switch control signal φ1R is 0.5 clock cycles.

Although not shown in the drawings, the switch control signals φ0W, φ1W, and WSW needed for a write operation are generated by a circuit similar to the control signal generation circuit 200 shown in FIG. 3.

Next, the operation of the semiconductor device 10a according to the present embodiment will be described.

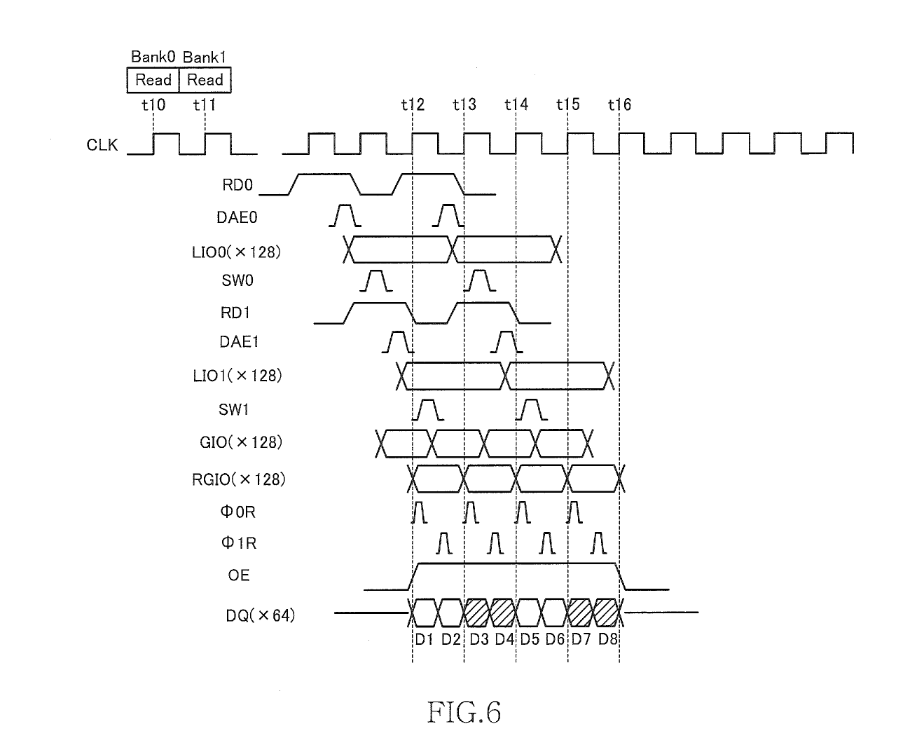

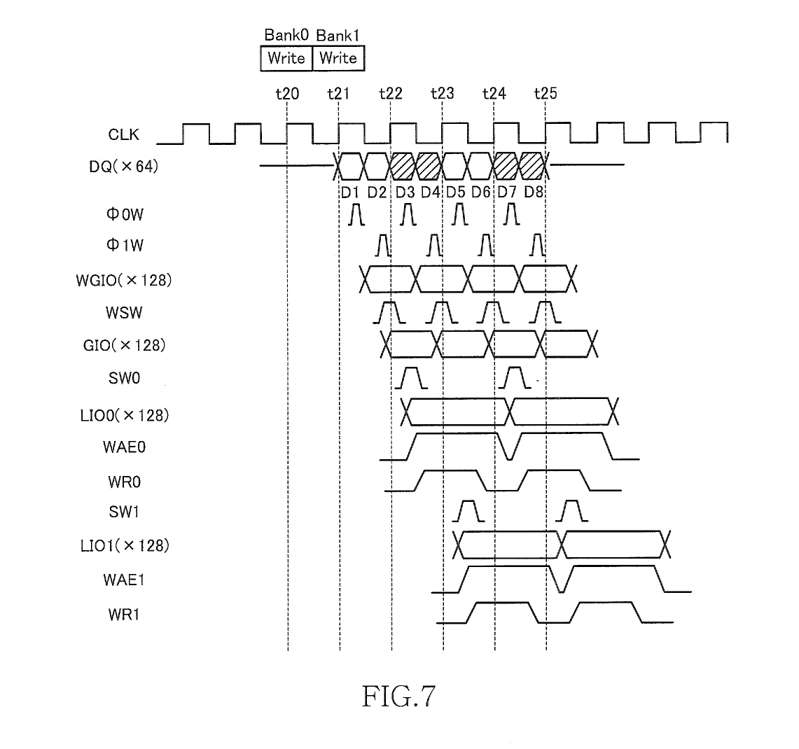

FIG. 6 is a timing chart for explaining an operation of the semiconductor device 10a according to the present embodiment. FIG. 6 shows bank interleaving in a read operation. The burst length is four bits. As described above, in the present embodiment, the number of data terminals 15 is 64. Consequently, 256 bits (=64×4) of read data is read from a memory bank in response to a single read command Read. In FIG. 6, the memory banks Bank0 and Bank1 are both assumed to have selected a predetermined word line WL according to an active command supplied from outside in advance. In other words, the memory banks Bank0 and Bank1 shall be activated in advance. Similarly, in FIGS. 7 to 10, 12, 14, 16, and 18 to be seen below, memory banks for a read command Read to be supplied to shall be activated in advance.

In the example shown in FIG. 6, a read command Read designated for the memory bank Bank0 is issued at time t10. A read command Read designated for the memory bank Bank1 is issued one clock cycle later at time t11. As shown in FIG. 6, in response to the read command Read at time t10, the read signal RD0 and the enable signal DAE0 are activated twice with an interval of two clock cycles. Such signals are activated twice because the burst length is set to four bits. As will be described later, if the burst length is set to two bits, both signals are activated only once. Although not shown in the drawings, if the burst length is set to eight bits, both signals are activated four times.

The first activation of the read signal RD0 and the enable signal DAE0 is intended to read the first two bits of read data to be burst-output. The second activation of the read signal RD0 and the enable signal DAE0 is intended to read the second two bits of read data to be burst-output.

When the enable signal DAE0 is activated, read data amplified by the data amplifier DAMP is transferred to the local I/O interconnection LIO0. As described above, the local I/O interconnection LIO0 has a data width of 128 bits. In other words, 256 bits of read data to be read from the memory bank in response to a single read command Read is output to the local I/O interconnection LIO0 in 128 bits twice. The read data output to the local I/O interconnection LIO0 is transferred to the global I/O interconnection GIO in two separate transactions in synchronization with the switch control signal SW0.

Such an operation is further performed on the memory bank Bank1 with a delay of one clock cycle. Consequently, 128 bits of read data read from the memory bank Bank0 and 128 bits of read data read from the memory bank Bank1 appear alternately on the global I/O interconnection GIO at an interval of one clock cycle. The read data transferred to the global I/O interconnection GIO is transferred to the global I/O interconnection RGIO through the FIFO circuit 60.

As described above, bank interleaving with a burst length of four bits is performed in the present example. As shown in FIG. 5, all the select signals BL1E to BL4E are at a high level. The switch control circuit φ0R is activated four times at intervals of one clock cycle. The switch control circuit φ1R is activated four times with a delay of 0.5 clock cycles from the switch control circuit φ0R.

The first activation of the switch control signals φ0R and φ1R defines the timing to output the first 128 bits of read data read from the memory bank Bank0. The second activation of the switch control signals φ0R and φ1R defines the timing to output the first 128 bits of read data read from the memory bank Bank1. The third activation of the switch control signals φ0R and φ1R defines the timing to output the second 128 bits of read data read from the memory bank Bank0. The fourth activation of the switch control signals φ0R and φ1R defines the timing to output the second 128 bits of read data read from the memory bank Bank1.

Consequently, in the period of four clock cycles from time t12 to time t16, read data DQ is continuously burst-output from the data terminals 15 in 0.5 clock cycles. As shown in FIG. 6, the apparent burst length is eight bits. The pieces of read data D1, D2, D5, and D6 are ones read from the memory bank Bank0. The pieces of read data D3, D4, D7, and D8 are ones read from the memory bank Bank1. The read data D1, D2, D5, and D6 is output in an output period between times t12 and t13 and an output period between times t14 and t15. The read data D3, D4, D7, and D8 is output in an output period between times t13 and t14 and an output period between times t15 and t16. The period between times t13 and t14, where the read data D3 and D4 is output, is an output suspension period of the bank memory Bank0. The period between times t14 and t15, where the read data D5 and D6 is output, is an output suspension period of the bank memory Bank1.

In the present embodiment, bank interleaving can thus be performed to continuously burst-output read data DQ twice as long as the specified burst length. This can increase the use efficiency of the data bus. Since 256 bits of read data to be read in response to a single read command Read is read from a memory bank in two separate operations, the number of bits of read data to be read by each read operation is reduced by half. The number of sense amplifiers to be simultaneously activated is thus reduced by half to allow suppression of the peak current and power supply noise. The two read operations corresponding to a read command Read are performed at an interval of two clock cycles, which can secure sufficient time needed for each read operation. Because of such characteristics, in the present embodiment, burst operations can be performed with a suppressed peak current and suppressed power supply noise even if the data terminals 15 are large in number and/or the external clock CLK has a high frequency.

A bank interleaving operation of the semiconductor device 10a in a write operation will be explained with reference to FIG. 7. The burst length is four bits.

In the example shown in FIG. 7, a write command Write designated for the memory bank Bank0 is issued at time t20. A write command Write designated for the memory bank Bank1 is issued one clock cycle later at time t21. In a period of four clock cycles from time t21 to time t25, write data DQ is continuously burst-input from the 64 data terminals 15 in 0.5 clock cycles. As shown in FIG. 7, the apparent burst length is eight bits. The pieces of write data D1, D2, D5, and D6 are ones to be written into the memory bank Bank0. The pieces of write data D3, D4, D7, and D8 are ones to be written into the memory bank Bank1. The write data D1, D2, D5, and D6 is input in an input period between times t21 and t22 and an input period between times t23 and t24. The write data D3, D4, D7, and D8 is input in an input period between times t22 and t23 and an input period between times t24 to t25. The period between times t22 and t23, where the write data D3 and D4 is input, is an input suspension period of the memory bank Bank0. The period between times t23 and t24, where the write data D5 and D6 is input, is an input suspension period of the memory bank Bank1.

In the present example, bank interleaving is performed with a burst length of four bits. The switch control signal φ0W is thus activated four times at intervals of one clock cycle. The switch control signal φ1W is activated four times with a delay of 0.5 clock cycles from the switch control signal φ0W.

The first activation of the switch control signals φ0W and φ1W defines the timing to accept the first 128 bits of write data to be written into the memory bank Bank0. The second activation of the switch control signals φ0W and φ1W defines the timing to accept the first 128 bits of write data to be written into the memory bank Bank1. The third activation of the switch control signals φ0W and φ1W defines the timing to accept the second 128 bits of write data to be written into the memory bank Bank0. The fourth activation of the switch control signals φ0W and φ1W defines the timing to accept the second 128 bits of write data to be written into the memory bank Bank1.

Consequently, 128 bits of write data to be written into the memory bank Bank0 and 128 bits of write data to be written into the memory bank Bank1 appear alternately on the global I/O interconnection WGIO at intervals of one clock cycle. The write data transferred to the global interconnection WGIO is transferred to the global I/O interconnection GIO through the switch circuit 74.

The write data transferred to the global I/O interconnection GIO is transferred to the local I/O interconnection LIO0 in synchronization with the switch control signal SW0, and transferred to the local I/O interconnection LIO1 in synchronization with the switch control signal SW1. The 128 bits of write data transferred to the local I/O interconnection LIO0 is written into selected memory cells MC in the memory bank Bank0 in response to the write signal WR0 and the enable signal WAE0. The 128 bits of write data transferred to the local I/O interconnection LIO1 is written into selected memory cells MC in the memory bank Bank1 in response to the write signal WR1 and the enable signal WAE1.

In a write operation, like a read operation, the write signals WR0 and WR1 and the enable signals WAE0 and WAE1 are activated twice at intervals of two clock cycles in response to a single write command Write. As a result, a write operation on each of the memory banks Bank0 and Bank1 is performed in two separate operations at an interval of two clock cycles. A similar operation as with a read operation can thus be implemented in a write operation.

As described above, the semiconductor device 10a according to the present embodiment can continuously output read data and input write data by performing bank interleaving. It should be noted that bank interleaving can be performed between different memory banks. Bank interleaving designated for an identical memory bank is disabled.

While the semiconductor device 10a according to the present embodiment can efficiently use the data bus as described above by performing bank interleaving, bank interleaving need not necessarily be performed in the present invention.

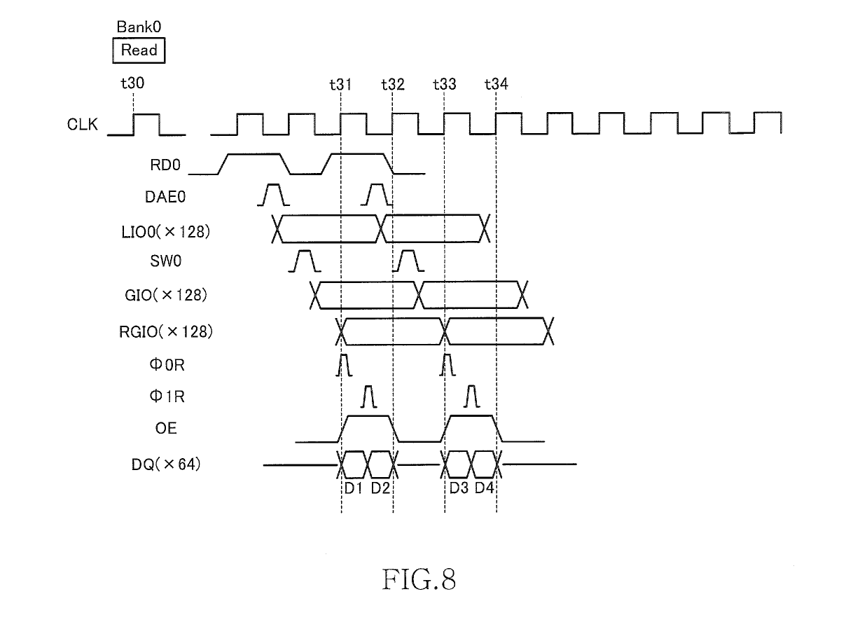

In the example shown in FIG. 8, a read command Read designated for the memory bank Bank0 is issued at time t30. No other command capable of bank interleaving with the read command Read is issued. The operation in response to the read command Read is the same as the read operation on the memory bank Bank0 shown in FIG. 6.

In the present embodiment, the four bits of read data D1 to D4 to be burst output are intermittently output in two separate operations. The first two-bit read data set D1 and D2 is output in an output period between times t31 and t32. The second two-bit read data set D3 and D4 is output in an output period between times t33 and t34. The period between times t32 and t33 is an output suspension period. In the present example, no data is input or output through the data terminals 15 in that suspension period. According to the present embodiment, a single read operation can be performed in such a manner. The single read operation is performed when bank interleaving is not allowed, i.e., when an identical memory bank needs to be consecutively accessed.

The read and write operations described with reference to FIGS. 6 to 8 do not use a so-called data strobe signal. A data strobe signal may be used to perform a read operation or write operation.

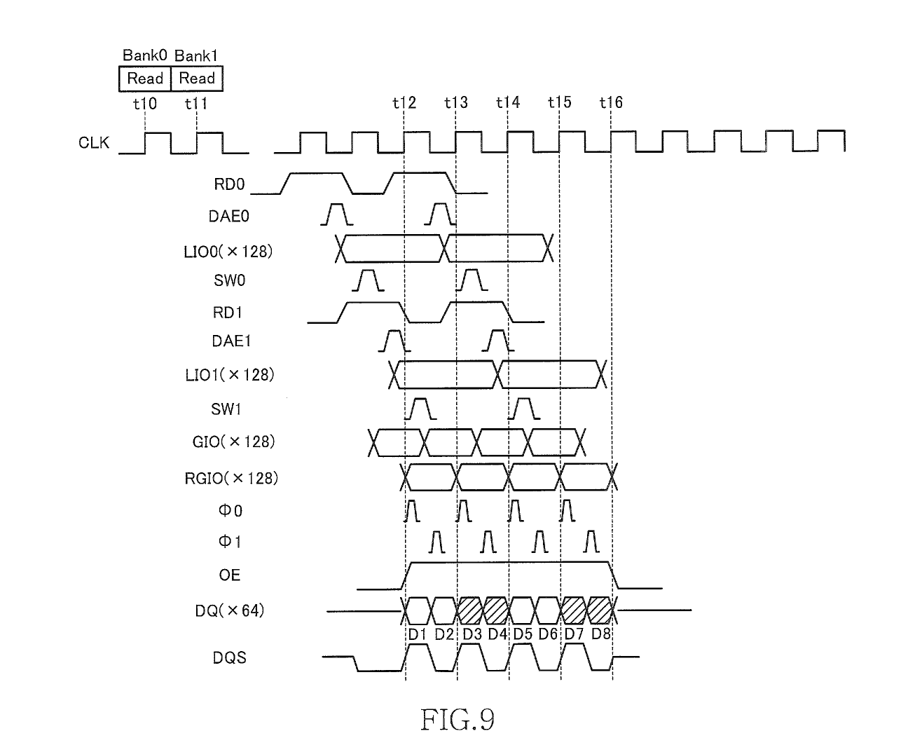

A bank interleaving operation of the semiconductor device 10a in a read operation will be explained with reference to FIG. 9. The operation shown in FIG. 9 is the same as shown in FIG. 6 except that the data strobe signal DQS is clocked in synchronization with the read data D1 to D8. The use of the data strobe signal DQS for a read operation facilitates controlling the latch timing of the read data on the control device side.

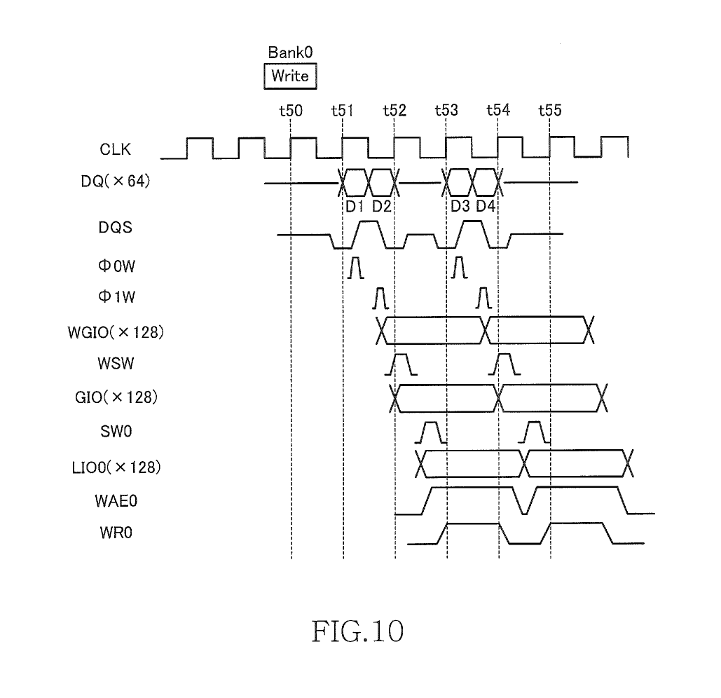

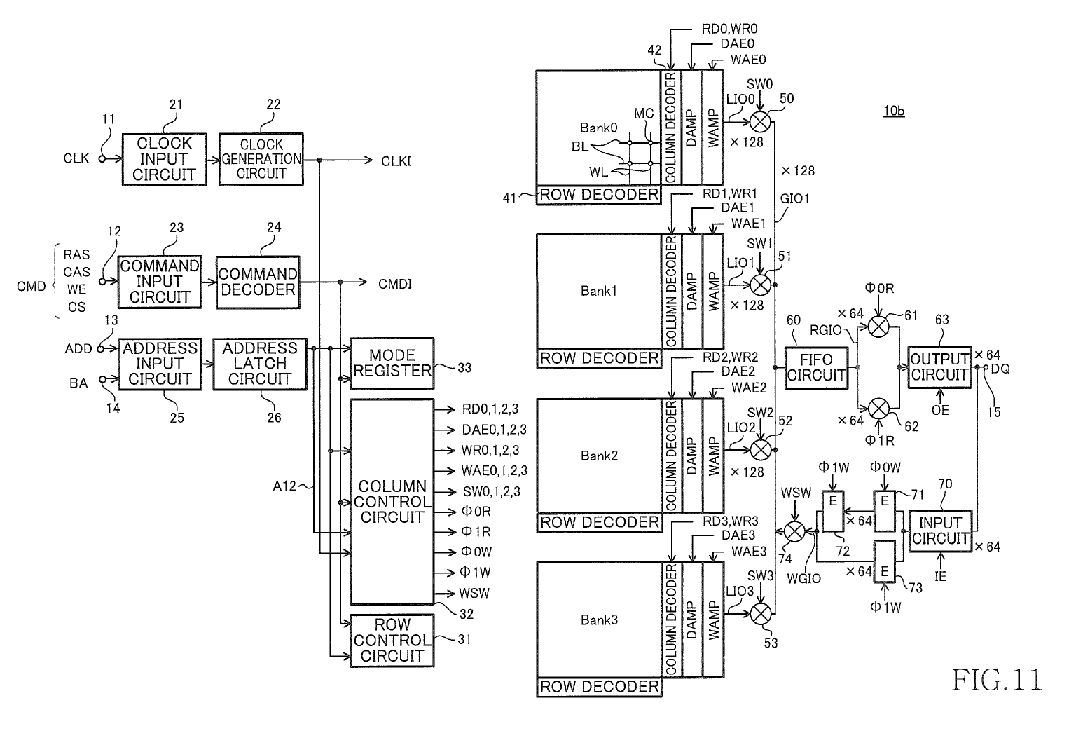

In the example shown in FIG. 10, a write command Write designated for the memory bank Bank0 is issued at time t50. No other command capable of bank interleaving with the write command Write is issued. The operation in response to the write command Write is the same as the write operation on the memory bank Bank0 shown in FIG. 7.

In the present example, the four bits of write data D1 to D4 to be burst-input is intermittently input in two separate operations. The first two-bit write data set D1 and D2 is input in an input period between times t51 and t52. The second two-bit write data set D3 and D4 is input in an input period between times t53 and t54. The period between times t52 and t53 is an input suspension period. In the present example, no data is input or output through the data terminals 15 in that suspension period. In the present example, the data strobe signal DQS is clocked in synchronization with the write data D1 to D4. The use of the data strobe signal DQS for a write operation facilitates controlling the latch timing of the write data on the side of the semiconductor device 10a. According to the present embodiment, a single write operation can be performed in such a manner.

The second embodiment of the present invention will be explained.

The semiconductor device 10b according to the second embodiment of the present invention differs from the semiconductor device 10a according to the first embodiment in that the burst length can be dynamically switched. A burst length is selected by using a predetermined bit or bits of the address signal ADD that is input in a column access. Since the number of bits of the address signal ADD to be input in a column access is smaller than that of the address signal ADD to be input in a row access, there are unused address bits. In the present embodiment, such unused address bits are utilized to select a burst length.

In the present embodiment, an address bit A12 input in a column access, though not limited thereto, is used as a select signal. If the logic level of the address bit A12 is low, the burst length is four bits. If the logic level is high, the burst length is two bits. The address bit A12 therefore needs to be supplied to the column control circuit 32 even in a column access. In other respects, the semiconductor device 10b has the same configuration as that of the semiconductor device 10a according to the first embodiment. The same components are therefore designated by the same reference symbols. A redundant description is omitted.

A read operation of the semiconductor device 10b according to the present embodiment will be explained where the burst length is two bits.

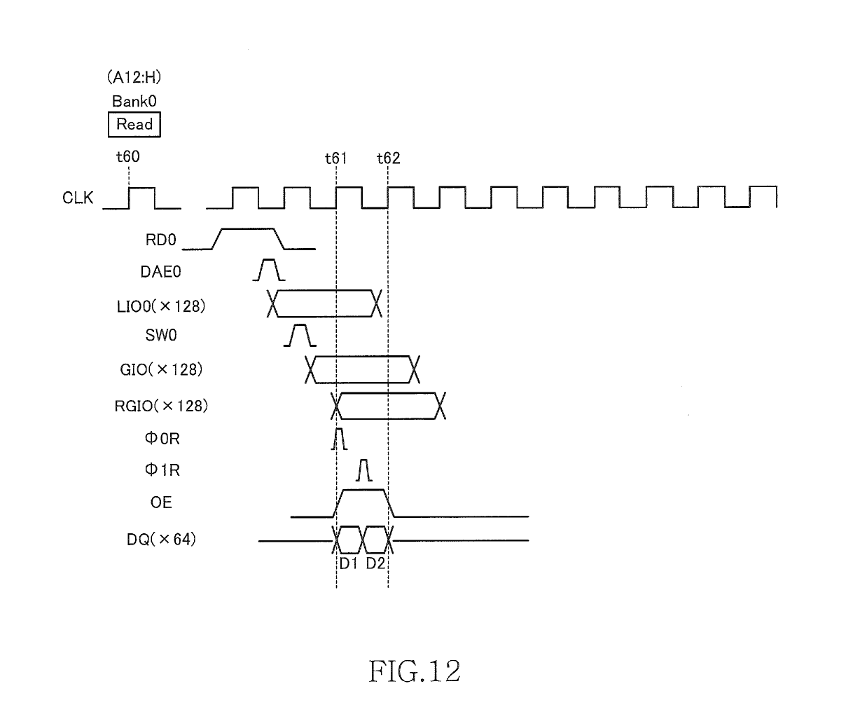

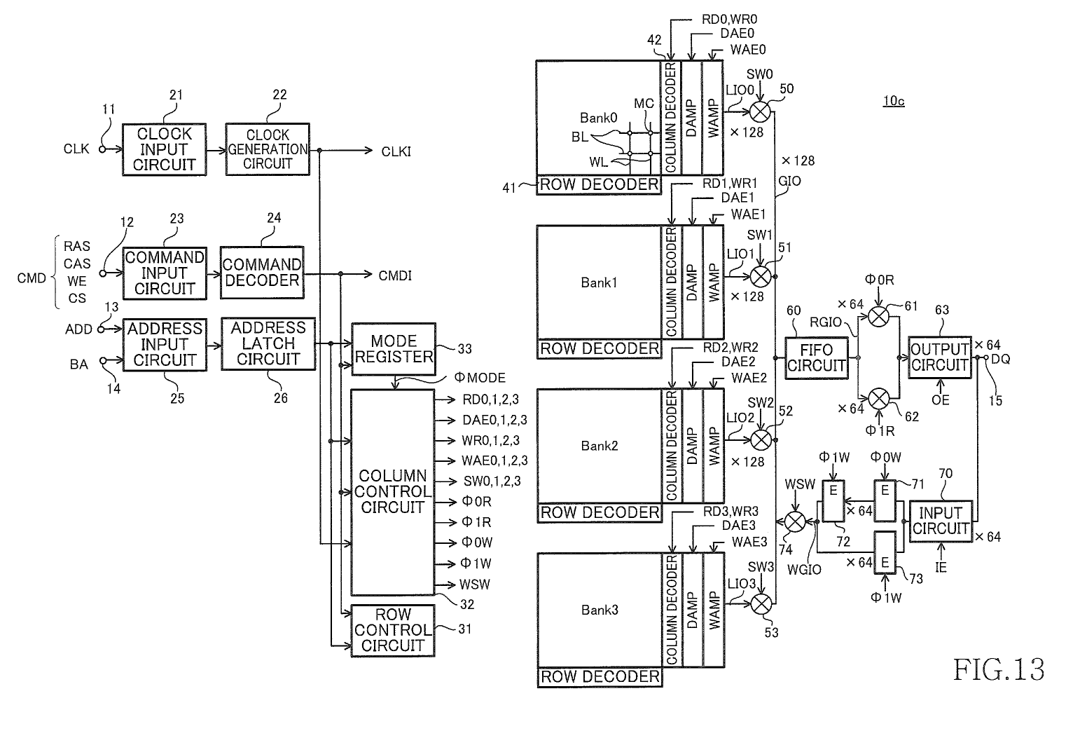

In the example shown in FIG. 12, a read command Read designated for the memory bank Bank0 is issued at time t60. No other command capable of bank interleaving with the read command Read is issued. In the present example, the burst length is specified to be two bits. Only the first read operation on the memory bank Bank0 among the read operations on the memory bank Bank0 shown in FIG. 6 is thus performed. The second read operation will not be performed. As shown in FIG. 12, the two bits of read data D1 and D2 is output in an output period between times t61 and t62. In the present embodiment, such dynamic switching of the burst length allows a wider variety of accesses.

The third embodiment of the present invention will be explained.

The semiconductor device 10c according to the third embodiment of the present invention differs from the semiconductor device 10a according to the first embodiment in that the output suspension period and the input suspension period can be switched by using the mode register 33. An output suspension period and an input suspension period are selected based on a mode select signal (MODE, a setting value of the mode register 33. The output suspension period and the input suspension period, which are fixed to one clock cycle in the first and second embodiments, can thus be expanded to two or more clock cycles. In other respects, the semiconductor device 10c has the same configuration as that of the semiconductor device 10a according to the first embodiment. The same components are therefore designated by the same reference symbols. A redundant description is omitted.

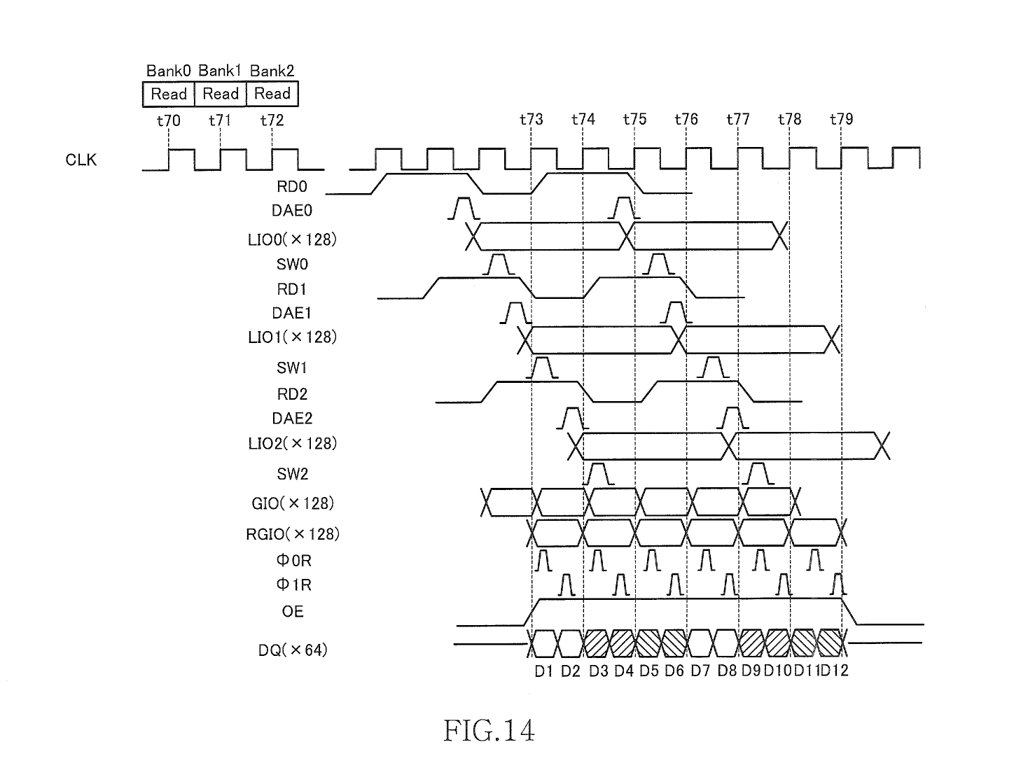

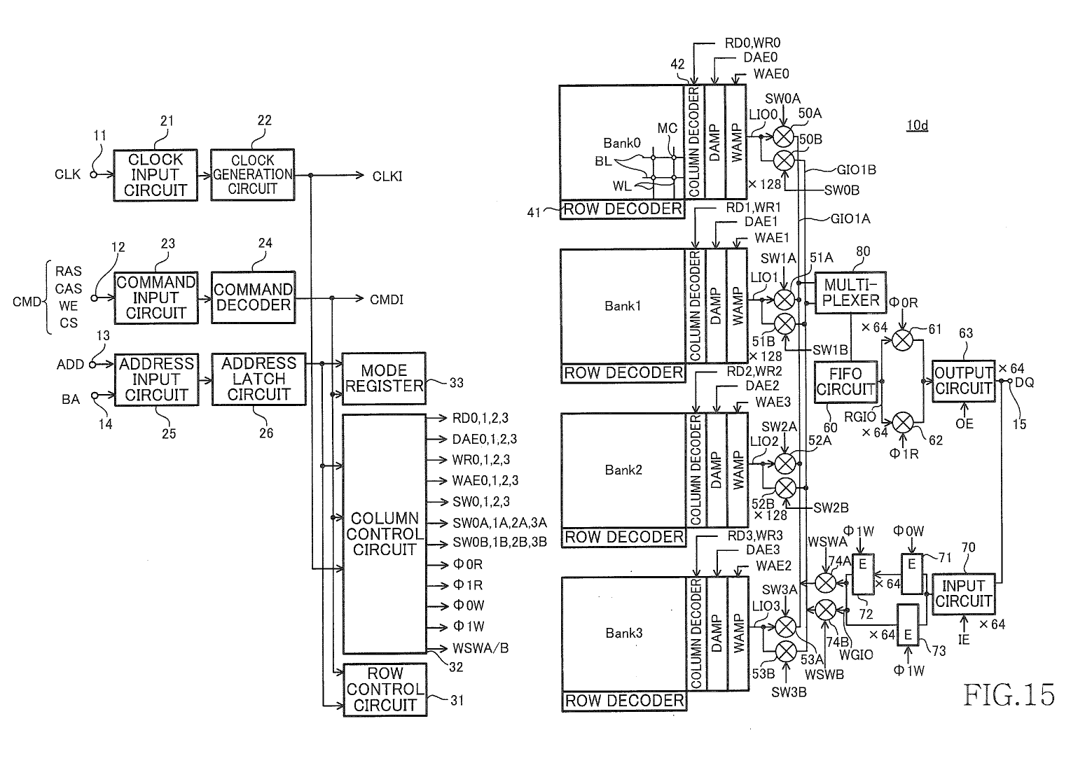

FIG. 14 is a timing chart for explaining an operation of the semiconductor device 10c according to the present embodiment. FIG. 14 shows bank interleaving in a read operation. The burst length is four bits. The output suspension period is two clock cycles.

In the example shown in FIG. 14, a read command Read designated for the memory bank Bank0 is issued at time t70. A read command Read designated for the memory bank Bank1 is issued one clock cycle later at time t71. A read command Read designated for the memory bank Bank2 is issued yet one clock cycle later at time t72. Operations in response to such read commands Read are the same as described with reference to FIG. 6 and the like. A redundant description is omitted.

In the example shown in FIG. 14, the output suspension period is expanded to two clock cycles. Among four bits of read data to be burst-output from each memory bank, the first two-bit read data set and the second two-bit read data set are output in an output period of one clock cycle each. Since the read commands Read are issued at intervals of one clock cycle, the read data D1 to D12 is continuously burst-output in a period of six clock cycles from time t73 to time t79.

As shown in FIG. 14, the apparent burst length is 12 bits. The pieces of read data D1, D2, D7, and D8 are ones read from the memory bank Bank0. The pieces of read data D3, D4, D9, and D10 are ones read from the memory bank Bank1. The pieces of read data D5, D6, D11, and D12 are ones read from the memory bank Bank2. In other words, bank interleaving is performed with the three banks Bank0 to Bank2.

In the present example, the read data D1, D2, D7, and D8 is output in an output period between times t73 and t74 and an output period between times t76 and t77. The read data D3, D4, D9, and D10 is output in an output period between times t74 and t75 and an output period between times t77 and t78. The read data D5, D6, D11, and D12 is output in an output period between times t75 and t76 and an output period between times t78 and t79. The period between times t74 and t76, where the read data D3 to D6 is output, is an output suspension period of the memory bank Bank0. The period between times t75 and t77, where the read data D5 to D8 is output, is an output suspension period of the memory bank Bank1. The period between times t76 and t78, where the read data D7 to D10 is output, is an output suspension period of the memory bank Bank2.

As described above, the semiconductor device 10c according to the present embodiment can change the output suspension periods by using a setting value of the mode register 33. The use efficiency of the data bus can thus be increased even if the external clock signal CLK has a high frequency. In FIG. 14, an example where the output suspension periods are set to two clock cycles has been described. If the external clock signal CLK has an even higher frequency, the output suspension periods may be set to three or more clock cycles, in which case bank interleaving can be performed with four or more memory banks. Although not shown in the drawings, the semiconductor device 10c according to the present embodiment can also change input suspension periods to perform bank interleaving with three or more memory banks in a write operation.

The fourth embodiment of the present invention will be explained.

The semiconductor device 10d according to the fourth embodiment of the present invention differs from the semiconductor device 10a according to the first embodiment in including two groups of global I/O interconnection GIO. One of the groups of global I/O interconnection, GIOA, is connected to local I/O interconnection LIO0 to LIO3 through switch circuits 50A to 53A. The other global I/O interconnection GIOB is connected to the local I/O interconnection LIO0 to LIO3 through switch circuits 50B to 53B. The switch circuits 50A to 53A are controlled by switch control signals SW0A to SW3A, respectively. The switch circuits 50B to 53B are controlled by switch control signals SW0B to SW3B, respectively.

The two groups of global I/O interconnection GIOA and GIOB are connected to a FIFO circuit 60 through a multiplexer 80. The multiplexer 80 is supplied with a select signal SEL from the column control circuit 32, and connects either one of the groups of global I/O interconnection GIOA and GIOB to the FIFO circuit 60 based on the select signal SEL. The global I/O interconnection WGIO is connected to global I/O interconnection WGIOA through a switch circuit 74A, and connected to global I/O interconnection WGIOB through a switch circuit 74B. The switch circuits 74A and 74B are controlled by switch control signals WSWA and WSWB, respectively.

In other respects, the semiconductor device 10d has the same configuration as that of the semiconductor device 10a according to the first embodiment. The same components are therefore designated by the same reference symbols. A redundant description is omitted.

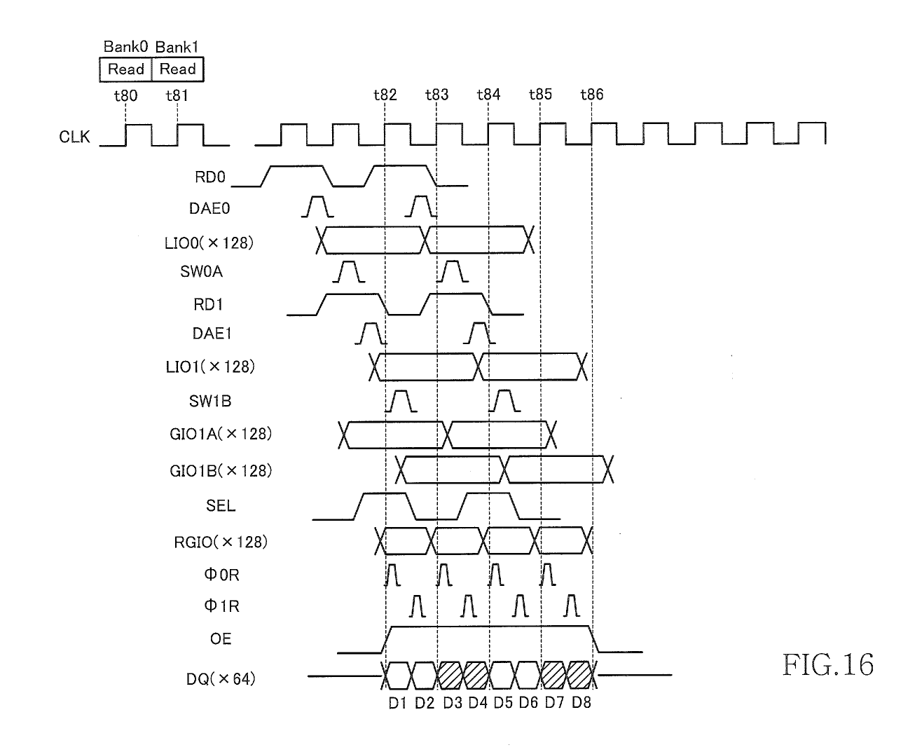

FIG. 16 is a timing chart for explaining an operation of the semiconductor device 10d according to the present embodiment. FIG. 16 shows bank interleaving in a read operation. The burst length is four bits.

In the example shown in FIG. 16, a read command Read designated for the memory bank Bank0 is issued at time t80. A read command Read designated for the memory bank Bank1 is issued one clock cycle later at time t81. The operations in response to such read commands Read are basically the same as described with reference to FIG. 6. In the present embodiment, the read data read from the memory bank Bank0 is transferred to the global I/O interconnection GIOA through the switch circuit 50A. The read data read from the memory bank Bank1 is transferred to the global I/O interconnection GIOB through the switch circuit 51B.

The select signal SEL is clocked at every clock cycle, whereby the pieces of read data transferred to the global I/O interconnection GIOA and GIOB are alternately transferred to the FIFO circuit 60 through the multiplexer 80. The subsequent operations are the same as described with reference to FIG. 6.

In the present embodiment, the transfer of read data during bank interleaving can be performed by using different groups of global I/O interconnection GIOA and GIOB for respective memory banks. The frequency of the read data on the global I/O interconnection GIOA and GIOB can thus be reduced by half as compared to the first to third embodiments.

Since the present embodiment uses the two groups of global I/O interconnection GIOA and GIOB, the number of lines of global I/O interconnection GIOA and GIOB needed is twice that of the first to third embodiments. More specifically, the first to third embodiments need 128 lines of global I/O interconnection GIO, and the present embodiment needs 256 lines.

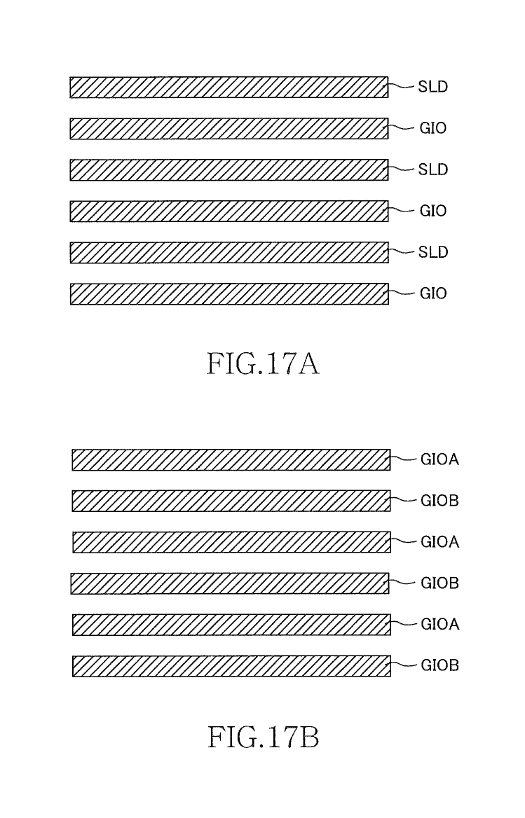

If there is provided only one system of global I/O interconnection GIO like the first to third embodiments, shield interconnection SLD may need to be arranged between the signal lines constituting the global I/O interconnection GIO, as shown in FIG. 17A, in order to reduce crosstalk noise. The shield interconnection SLD mainly includes power supply lines.

In the present embodiment, as shown in FIG. 17B, the signal lines constituting the global I/O interconnection GIOA and those constituting the global I/O interconnection GIOB can be alternately laid out. Since one of the groups of global I/O interconnection GIOA and GIOB functions as shield interconnection for the other, no additional shield interconnection needs to be provided. The reason for such an effect is as follows: The timing of change of the read data on the global I/O interconnection GIOA, as described with reference to FIG. 16, differs one clock cycle from that of the read data on the global I/O interconnection GIOB. When either one of the groups of global I/O interconnection GIOA and GIOB changes in potential, the other is always fixed to a high level or low level. Consequently, the semiconductor device 10d according to the present embodiment will not increase significantly in the chip area as compared to the semiconductor devices 10a to 10c according to the first to third embodiments.

FIG. 16 has dealt with an example of bank interleaving in a read operation. It will be understood that bank interleaving using the two groups of global I/O interconnection GIOA and GIOB can also be performed in a write operation. The semiconductor device 10d according to the present embodiment is even capable of bank interleaving with a combination of a read operation and a write operation.

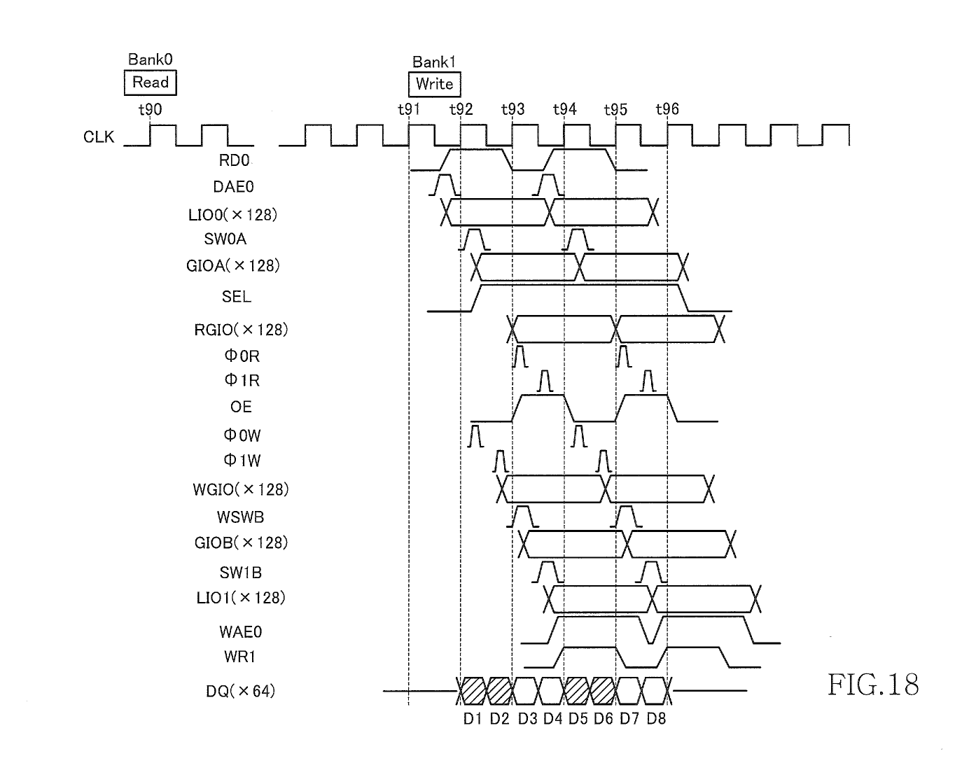

FIG. 18 is a timing chart for explaining an operation of the semiconductor device 10d according to the present embodiment. FIG. 18 shows bank interleaving with a combination of a read operation and a write operation. The burst length is four bits.

In the example shown in FIG. 18, a read command Read designated for the memory bank Bank0 is issued at time t90. A write command Write designated for the memory bank Bank1 is issued at time t91. The operation in response to the read command Read is the same as the read operation on the memory bank Bank0 shown in FIG. 6. The operation in response to the write command Write is the same as the write operation on the memory bank Bank1 shown in FIG. 7.

In the present example, among the data input and output through the data terminals 15, the pieces of data D1, D2, D5, and D6 are write data to be written into the memory bank Bank1. The pieces of data D3, D4, D7, and D8 are read data read from the memory bank Bank0. The write data D1, D2, D5, and D6 is input in an input period between times t92 and t93 and an input period between times t94 and t95. The read data D3, D4, D7, and D8 is output in an output period between times t93 and t94 and an output period between times t95 and t96. The period between times t94 and t95, where the write data D5 and D6 is input, is an output suspension period of the memory bank Bank0. The period between times t93 to t94, where the read data D3 and D4 is output, is an input suspension period of the memory bank Bank1.

As shown in FIG. 18, in the present embodiment, the read data read from the memory bank Bank0 is transferred to the global I/O interconnection GIOA while the write data to be written into the memory bank Bank1 is transferred to the global I/O interconnection GIOB. The bank interleaving with a combination of a read operation and a write operation can thus be achieved without conflict between the read data and write data.

Although not shown in the drawings, in the present embodiment, like the semiconductor device 10b according to the second embodiment, a certain address bit or bits (for example, A12) may be used to dynamically switch the burst length. Like the semiconductor device 10c according to the third embodiment, the output suspension period and/or the input suspension period may be made variable.

The fifth embodiment of the present invention will be explained.

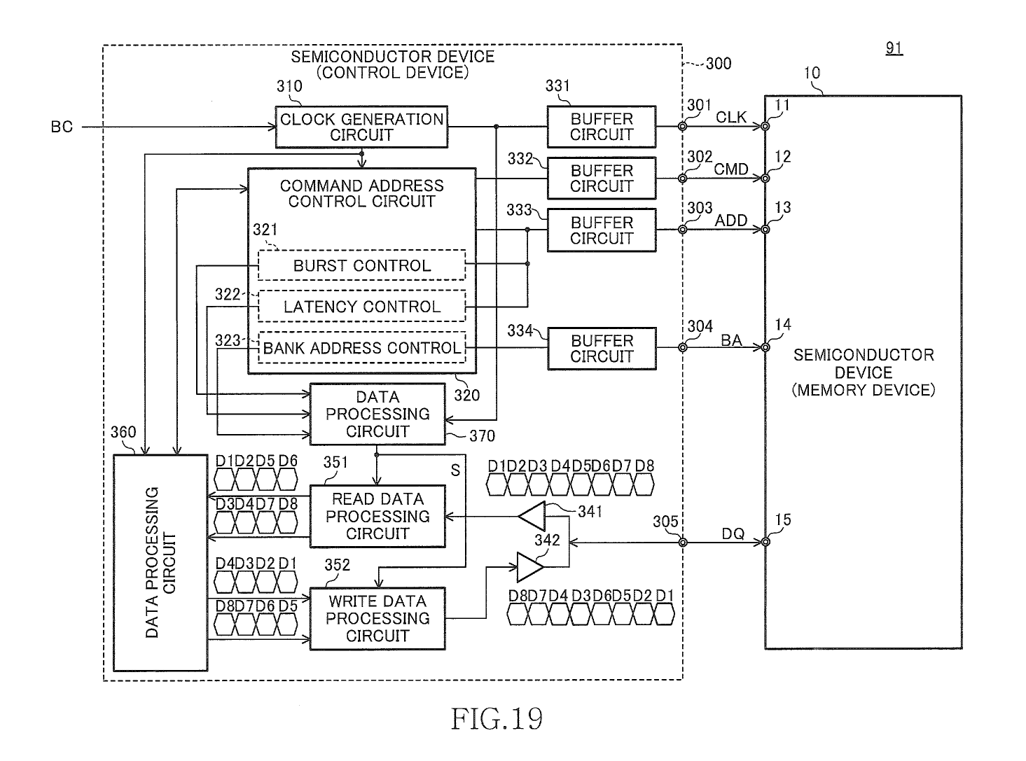

The information processing system 91 shown in FIG. 19 includes a semiconductor device 300 which functions as a control device, and a semiconductor device 10 which functions as a memory device. The semiconductor devices 10a to 10d according to the foregoing first to fourth embodiments may be used as the semiconductor device 10. The semiconductor device 300 as a control device is integrated as a semiconductor chip separate from the semiconductor device 10 as a memory device. The semiconductor device 300 issues the foregoing various commands (read command and write command) to the semiconductor device 10, and transmits and receives read data and write data to/from the semiconductor device 10.

As shown in FIG. 19, the semiconductor device 300 as a control device includes a clock generation circuit 310 which generates an external clock signal CLK, and a command address control circuit 320 which generates external command signals CMD, an address signal ADD, and a bank address signal BA. The clock generation circuit 310 generates the external signal clock CLK based on a base clock signal BC supplied from outside, and outputs the external signal clock CLK through a buffer circuit 331 and a clock terminal 301. The output external clock signal CLK is supplied to the clock terminal 11 of the semiconductor device 10.

The command address control circuit 320 includes a burst control circuit 321, a latency control circuit 322, and a bank address control circuit 323. The burst control circuit 321 controls the burst length. The latency control circuit 322 controls a read latency and a write latency. The bank address control circuit 323 designates a memory bank to access. When performing mode register setting on the semiconductor device 10, the command address control circuit 320 acquires a burst length setting code from the burst control circuit 321 and a latency setting code from the latency control circuit 322, and outputs the codes through a buffer circuit 333 and an address terminal 303. A mode register setting command is output through a buffer circuit 332 and a command terminal 302. The address signal ADD output in synchronization with the mode register setting command serves as a mode signal for rewriting the mode register 33 of the semiconductor device 10.

When making the semiconductor device 10 actually perform a read operation and a write operation, the command address control circuit 320 issues the external command signals CMD, and outputs an address signal ADD and a bank address signal BA of the access designation. The bank address signal BA of the access destination is generated by the bank address control circuit 323, and output through a buffer circuit 334 and a bank address terminal 304. As a result, the semiconductor device 10 can perform the foregoing read operation and write operation.

Data transfer from the semiconductor device 10 to the semiconductor device 300, i.e., a read operation of the semiconductor device 10 will be described with reference to the timing chart of FIG. 6 which shows a read operation of the semiconductor device 10a. Initially, the semiconductor device 300 supplies the external clock signal CLK to the clock terminal 11 of the semiconductor device 10. In the meantime, the semiconductor device 300 supplies the external command signals CMD serving as a read command to the command terminal 12 of the semiconductor device 10, the address signal ADD serving as a column address to the address terminal 13 of the semiconductor device 10, and a bank address BA indicating the memory bank Bank0 of the semiconductor device 10 to the bank address terminal 14 of the semiconductor device 10. One clock cycle later, the semiconductor device 300 supplies the external command signals CMD serving as a read command to the command terminal 12 of the semiconductor device 10, the address ADD serving as a column address to the address terminal 13 of the semiconductor device 10, and a bank address BA indicating the memory bank Bank1 of the semiconductor device 10 to the bank address terminal 14 of the semiconductor device 10. Here, the bank address control circuit 323 of the command address control circuit 320 of the semiconductor device 300 retains the bank addresses it has issued, namely, the bank address indicating the memory bank Bank0 and the bank address indicating the memory bank Bank1 along with information about the order of generation of the bank addresses. In response to the read commands supplied from the semiconductor device 300, the semiconductor device 10 performs read operations as described above. Since the details of the operations are the same as have been described above, a description thereof will be omitted.

When the semiconductor device 10 performs a read operation, read data DQ is burst-input to the semiconductor device 300 through data terminals 305. The input read data DQ is supplied to a read data processing circuit 351 through an input buffer 341. As has been described above, when bank interleaving is performed in a read operation, read data sets read from a plurality of memory banks are alternatively output. In the example shown in FIG. 19, among the read data D1 to D8 input in that order, the pieces of read data D1, D2, D5, and D6 are ones read from one memory bank (for example, memory bank Bank0). The pieces of read data D3, D4, D6, and D8 are ones read from another memory bank (for example, memory bank Bank1). The read data processing circuit 351 sorts such a plurality of pieces of read data read from different memory banks based on a select signal S, and transfers the resultant as two groups of burst data to a data processing circuit 360. As a result, burst data including the read data D1, D2, D5, and D6 and burst data including the read data D3, D4, D7, and D8 are continuously input to the data processing circuit 360 in parallel. In other words, by bank interleaving, read data stored in a plurality of memory banks in a distributed manner can be reproduced as pieces of data of the respective memory banks.

The select signal S is generated by a data control circuit 370. The data control circuit 370 switches the logic level of the select signal S at predetermined timing in synchronization with the external clock signal CLK based on output signals from the command address control circuit 320. Specifically, the data control circuit 370 switches the logic level of the select signal S at predetermined timing according to burst information retained in the burst control circuit 321 of the command address control circuit 320, latency information retained in the latency control circuit 322, and bank address information (including the order of generation of bank addresses upon issuance of read commands) retained in the bank address generation circuit 323. The data control circuit 370 thereby controls the sorting of data by the read data processing circuit 351.

Next, data transfer from the semiconductor device 300 to the semiconductor device 10, i.e., a write operation of the semiconductor device 10 will be described with reference to the timing chart of FIG. 7 which shows a write operation of the semiconductor device 10a. Initially, the semiconductor device 300 supplies the external clock signal CLK to the clock terminal 11 of the semiconductor device 10. In the meantime, the semiconductor device 300 supplies the external command signals CMD serving as a write command to the command terminal 12 of the semiconductor device 10, the address signal ADD serving as a column address to the address terminal 13 of the semiconductor device 10, and a bank address BA indicating the memory bank Bank0 of the semiconductor device 10 to the bank address terminal 14 of the semiconductor device 10. One clock cycle later, the semiconductor device 300 supplies the external command signals CMD serving as a write command to the command terminal 12 of the semiconductor device 10, the address signal ADD serving as a column address to the address terminal 13 of the semiconductor device 10, and a bank address BA indicating the memory bank Bank1 of the semiconductor device 10 to the bank address terminal 14 of the semiconductor device 10. Inside the semiconductor device 300, the data processing circuit 360 outputs write data D1 to D8 in two separate groups in parallel. In the example shown in FIG. 19, serial write data D1 to D4 and serial write data D5 to D8 are output from the data processing circuit 360 in parallel. The write data D1 to D8 is supplied to a write data processing circuit 352, and serially converted based on the select signal S. The serially-converted write data D1, D2, D5, D6, D3, D4, D7, and D8 is supplied to the semiconductor device 10 in that order through an output buffer 342 and the data terminals 305. The semiconductor device 10 performs bank interleaving in a write operation, whereby the write data D1, D2, D5, and D6 is written into one memory bank (for example, memory bank Bank0) and the write data D3, D4, D7, and D8 into another memory bank (for example, memory bank Bank1). Such a write operation is the same as described with reference to FIG. 7.

As has been described above, the information processing system 91 according to the present embodiment uses a control device suited to the semiconductor devices 10a to 10d according to the first to fourth embodiments. This facilitates the handling of data that is stored in a plurality of memory banks in a distributed manner.

The sixth embodiment of the present invention will be explained.

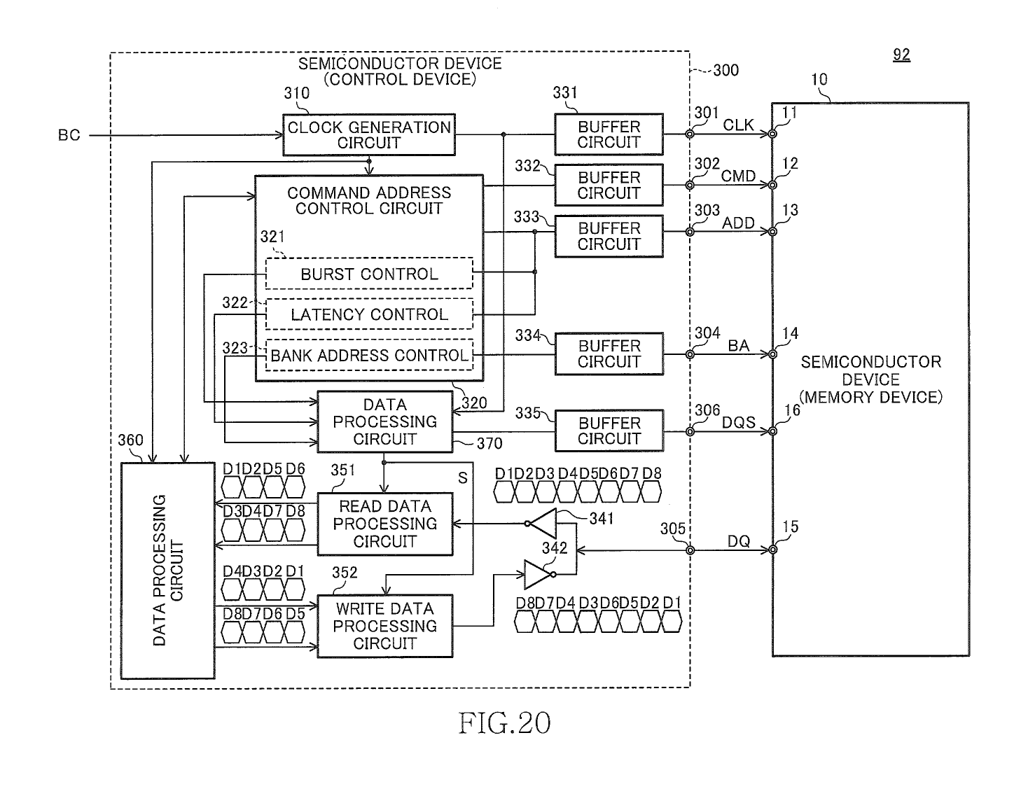

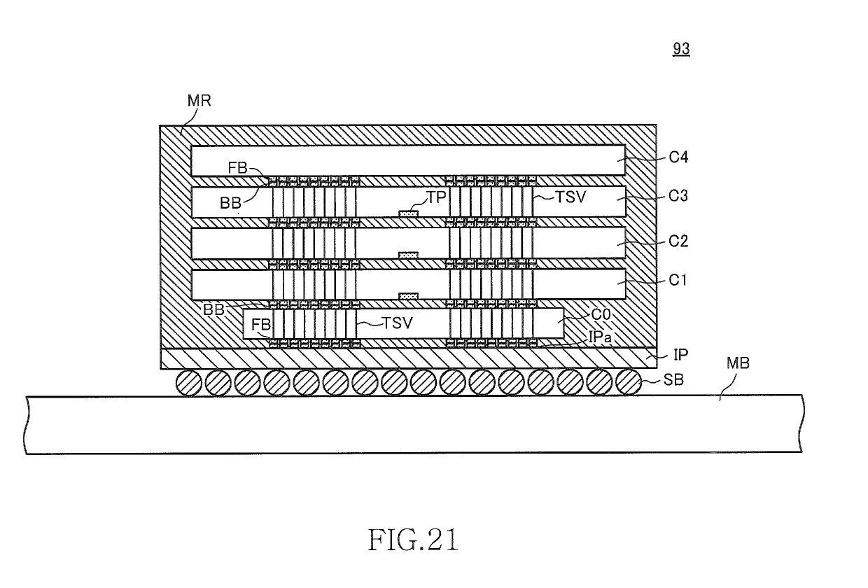

The information processing system 92 shown in FIG. 20 differs from the foregoing information processing system 91 in using a data strobe signal DQS. More specifically, the semiconductor device 300 as a control device includes a buffer circuit 335 and a terminal 306 intended for the data strobe signal DQS. The semiconductor device 10 as a memory device includes a terminal 16 intended for the data strobe signal DQS. The semiconductor device 300 generates the data strobe signal DQS by using a data control circuit 370. In other respects, the information processing system 92 is the same as the foregoing information processing system 91. The same components are therefore designated by the same reference symbols. A redundant description is omitted. Since the information processing system 92 according to the present embodiment uses the data strobe signal DQS to transmit and receive read data and write data, the read data and write data can be properly accepted even if the external clock signal CLK has a high frequency.

The seventh embodiment of the present invention will be explained.

The information processing system 93 according to the present embodiment has a structure that a semiconductor chip C0 functioning as a control device and four semiconductor chips C1 to C4 functioning as a memory device are stacked. Each of the semiconductor chips C1 to C4 functions as a DRAM by itself. The semiconductor devices 10a to 10d according to the foregoing first to fourth embodiments may be used as the semiconductor chips C1 to C4.

The semiconductor chips C0 to C4 are stacked on a package substrate IP by a face-down method. The face-down method refers to that the semiconductor chips are mounted so that their main surfaces where transistors and other electronic circuits are formed are directed downward, i.e., toward the package substrate IP. However, the present invention is not limited thereto, and the semiconductor chips may be stacked by a face-up method. The face-up method refers to that the semiconductor chips are mounted so that their main surfaces where transistors and other electronic circuits are formed are directed upward, i.e., to the side opposite from the package substrate IP. Some of the semiconductor chips may be stacked by the face-down method while the other(s) is/are stacked by the face-up method.

Of the semiconductor chips C0 to C4, the semiconductor chips C0 to C3 except the semiconductor chip C4 lying at the uppermost layer include a large number of through electrodes TSV (Through Silicon Via) which run through the respective silicon substrates. Surface bumps FB are formed on the main surface sides of the chips, and backside bumps BB on the backsides of the chips, at positions overlapping the through electrodes TSV when seen in a plan view taken in the stacking direction. The backside bumps BB of semiconductor chips lying in lower layers are joined to the surface bumps FB of semiconductor chips lying in upper layers, whereby the vertically-adjoining semiconductor chips are electrically connected to each other.

In the present embodiment, the semiconductor chip C4 at the uppermost layer includes no through electrode TSV. The reason is that the semiconductor chip C4 needs no bump electrode on the backside due to the face-down stacking. Without a through electrode TSV, the semiconductor chip C4 at the uppermost layer can be made thicker than the other semiconductor chips C0 to C3. This can increase the mechanical strength of the semiconductor chip C4. Note that according to the present invention, the semiconductor chip C4 at the uppermost layer may include through electrodes TSV. In such a case, the semiconductor chips C1 to C4 can be manufactured by the same processes.

With such a configuration, an external clock signal CLK, external command signals CMD, an address signal ADD, a bank address signal BA, write data DQ, and the like output from the semiconductor chip C0 functioning as a control device are supplied to the four semiconductor chips C1 to C4 in common. Read data DQ to be supplied from the semiconductor chips C1 to C4 to the semiconductor chip C0 is wired-ORed and input into the semiconductor chip C0. It should be noted that the data path need not necessarily be connected to all the semiconductor chips C1 to C4 in common. The semiconductor chips C1 to C4 may be individually connected to the semiconductor chip C0. The semiconductor chips C1 and C2 may form a common data path while the semiconductor chips C3 and C4 form a common path.

The surface bumps FB of the semiconductor chip C0 are connected to substrate electrodes IPa formed on the package substrate IP, and connected to solder balls SB on the backside through wiring on the package substrate IP and inside the package substrate IP. The package substrate IP and the semiconductor chips C0 to C4 are sealed with molding resin MR to constitute a multichip module.

The information processing system 93 (multichip module) having such a configuration is mounted on a wiring substrate MB such as a motherboard. Other semiconductor chips, such as a MPU and a CPU, and electronic parts are also mounted on the wiring substrate MB. Since the package substrate IP includes an insulator and conductors on the surface or inside of the insulator, the package substrate IP may be regarded as a kind of wiring substrate.

The foregoing seventh embodiment of the present invention has dealt with an example where the semiconductor chips C1 to C4 each include any one of the semiconductor devices 10a to 10d according to the foregoing first to fourth embodiments, i.e., a chip that functions as a so-called DRAM by itself. However, according to the present invention, the number of semiconductor devices 10a, 10b, 10c, or 10d included in each of the semiconductor chips C1 to C4 is not limited to one. More specifically, the semiconductor chips C1 to C4 each may include a plurality of semiconductor devices 10a, 10b, 10c, or 10d that function as a so-called DRAM by themselves. Similarly, the semiconductor chip C0 may be a semiconductor chip including a plurality of control devices.

It is apparent that the present invention is not limited to the above embodiments, but may be modified and changed without departing from the scope and spirit of the invention.

What is claimed is:

1. A semiconductor device comprising:
a command terminal configured to receive a read command;
a plurality of memory banks;
a control circuit configured to respond to each of issuance of the read command to perform a read operation on one of the memory banks so that the one of the memory banks outputs a plurality of read data sets; and
an output circuit configured to output the read data sets to outside in response to a clock signal so that a first interval is interposed between the read data sets, the first interval being substantially the same as a clock cycle of the clock signal or longer than the clock cycle.

2. The semiconductor device as claimed in claim 1, wherein the one of the memory banks outputs the read data sets in a time division manner in the read operation.

3. The semiconductor device as claimed in claim 1, wherein each of the read data sets includes one or more read data.

4. The semiconductor device as claimed in claim 1, wherein the control circuit is configured to perform, when a select signal supplied in association with the read command takes first logic level, the read operation on the one of the memory banks so that the one of the memory banks outputs the read data sets in a time division manner, and to perform, when the select signal takes a second logic level, the read operation on the one of the memory banks so that the one of the memory banks outputs one of the read data sets without outputting remaining one or ones of the read data sets.

5. The semiconductor device as claimed in claim 1, further comprising a mode register configured to store information that designates a length of the first interval.

6. The semiconductor device as claimed in claim 1, wherein
the memory banks include at least first and second memory banks,
the control circuit is configured to respond to one of the issuance of the read command to perform the read operation on the first memory bank so that the first memory bank outputs first and second read data sets in a time division manner, and configured to respond to another one of the issuance of the read command, that follows the one of the issuance, to perform the read operation on the second memory bank so that the second memory bank outputs third and fourth read data sets in a time division manner, and
the output circuit is configured to output the first, third, second, and fourth read data sets to outside in that order in response to the clock signal.

7. The semiconductor device as claimed in claim 1, wherein each of the memory banks includes a data amplifier that amplifies the read data sets,
the semiconductor device further comprising:
a first signal line group connected to the data amplifiers in common;
a second signal line group connected to the data amplifiers in common; and
a select circuit selectively connecting one of the first and second signal line groups to the output circuit.

8. The semiconductor device as claimed in claim 7, wherein
the first signal line group includes a plurality of first signal lines,
the second signal line group includes a plurality of second signal lines, and
the first signal lines and the second signal lines are alternately arranged.

9. The semiconductor device as claimed in claim 1, further comprising an input circuit configured to receive a plurality of write data sets from outside in response to the clock signal, the write data sets being supplied with a second interval substantially the same as the clock cycle or longer than the clock cycle interposed therebetween,
wherein the command terminal is further configured to receive a write command, and the control circuit is further configured to respond to each of issuance of the write command to perform a write operation on one of the memory banks so that the input circuit supplies the write data sets into the one of the memory banks.

10. The semiconductor device as claimed in claim 9, wherein the input circuit is configured to supply the write data sets into the one of the memory banks in a time division manner in response to the write command.

11. The semiconductor device as claimed in claim 9, further comprising a data terminal configured to receive the read data sets and the write data sets, and wherein
the memory banks include at least first and second memory banks,
the control circuit is configured to respond to one of the issuance of the read command to performs the read operation on the first memory bank so that the first memory bank outputs first and second read data sets in a time division manner, and configured to respond to one of the issuance of the write command, that follows the one of the issuance of the read command, to perform the write operation on the second memory bank so that the input circuit supplies first and second write data sets into the second memory bank in a time division manner, and
the data terminal is configured to receive the first read data set, the first write data set, the second read data set and the second write data set in this order.

12. The semiconductor device as claimed in claim 9, further comprising a data terminal configured to receive the read data sets and the write data sets, and wherein
the memory banks include at least first and second memory banks,
the control circuit is configured to respond to one of the issuance of the read command to performs the read operation on the first memory bank so that the first memory bank outputs first and second read data sets in a time division manner, and configured to respond to one of the issuance of the write command, that follows the one of the issuance of the read command, to perform the write operation on the second memory bank so that the input circuit supplies first and second write data sets into the second memory bank in a time division manner, and
the data terminal is configured to receive the first write data set, the first read data set, the second write data set and the second read data set in this order.

13. A device comprising:
a command terminal configured to receive a read command;
a data terminal;
a first memory bank configured to store a plurality of first data, the first data including first and second read data;
a holding circuit coupled to the first memory bank and configured to hold a first number of data;
an output circuit coupled between the holding circuit and the data terminal; and
a control circuit configured to respond to a first issuance of the read command to produce first and second access signals, and
wherein the first memory bank outputs the first read data to the output circuit with an intervention of the holding circuit in response to the first access signal and outputs the second read data to the output circuit with an intervention of the holding circuit in response to the second access signal, the output circuit intermittently supplies the first and second read data to the data terminal, and each of the first and second read data is equal in data size to the first number of data.

14. The device as claimed in claim 13, further comprising
a second memory bank configured to store a plurality of second data that includes third and fourth read data, and wherein the control circuit configured to respond to a second issuance of the read command, that follows the first issuance of the read command, to produce the third and fourth access signals so that the third access signal is produced between the first and second access signals and the second access signal is produced between the third and fourth access signals, the second memory bank outputs the third read data to the output circuit with an intervention of the holding circuit in response to the third access signal and outputs the fourth read data to the output circuit with an intervention of the holding circuit in response to the fourth access signal, the output circuit supplies the first, second, third and fourth read data to the data terminal so that the third read data is produced between the first and second read data and the second read data is produced between the third and fourth read data, and each of the first, second, third and fourth read data is equal in data size to the first number of data.

15. The device as clamed in claim 13, wherein the holding circuit includes a FIFO circuit.

16. A device comprising:
a plurality of memory banks;
a command terminal operatively receiving a read command;
an address terminal operatively receiving a bank address that designates one of the memory banks; and
a register circuit operatively storing burst length information that designates the number of read data output from the data terminal in response to each issuance of the read command,
wherein the device operatively responds to a first issuance of the read command to output a plurality of sets of first read data from one of the memory banks designated by a first bank address, the sets of first read data include the number of data designated by the burst length information, and the device operatively intermittently produces the sets of first read data at the output terminal.

17. The device as claimed in claim 16, wherein the device operatively responds to a second issuance of the read command, that follows the first issuance of the read command, to output a plurality of sets of second read data from one of the remaining one or ones of the memory banks designated by a second bank address, the sets of second read data include the number of data designated by the burst length information, and the device operatively alternately produce the sets of first read data and the sets of second read data at the output terminal.

18. The device as claimed in claim 17, wherein the sets of first read data include first and second sets of first read data and the sets of second read data include third and fourth sets of second read data, and the device operatively produce, at the data terminal, the third set of the second read data between the first and second sets of the first read data and the second set of the first read data between the third and fourth sets of second read data.

19. The device as claimed in claim 18, wherein the device operatively continuously produce, at the output terminal, the first and second sets of first read data and the third and fourth sets of second read data.
